(19) United States
(12) Patent Application Publication
(10) Pub. No.: US 2005/0242729 A1
(43) Pub. Date: Nov. 3, 2005

(54) Plasma display panel

(76) Inventor: Tae-Joung Kweon, Suwon-si (KR)

Correspondence Address: Robert E. Bushnell, Suite 300, 1522 K Street, N.W., Washington, DC, 20005-1202, US

(21) Appl. No.: 11/115,196

(22) Filed: Apr. 27, 2005

(30) Foreign Application Priority Data
Apr. 28, 2004 (KR) 10-2004-0029582

(51) Int. Cl. H01J 11/02

(52) U.S. Cl. 313/586; 313/584

(57) ABSTRACT

A plasma display panel (PDP) with improved driving efficiency, luminous efficiency, and daylight contrast. The PDP includes a transparent upper substrate, a lower substrate located parallel to the upper substrate, a plurality of first barrier ribs that are made of a transparent dielectric material and arranged between the upper and lower substrates and define discharge cells in combination with the upper and lower substrates, top discharge electrodes within the first barrier ribs to surround the discharge cells, each electrode having a dark-colored top surface, bottom discharge electrodes also within the first barrier ribs and also surround the discharge cells and spaced apart from the top discharge electrodes, a phosphor layer formed within the discharge cells and a discharge gas filling the discharge cell.

### CLAIM OF PRIORITY

This application makes reference to, incorporates the same herein, and claims all benefits accruing under 35 U.S.C. § 119 from an application for PLASMA DISPLAY PANEL earlier filed in the Korean Intellectual Property Office on Apr. 28, 2004 and there duly assigned Serial No. 10-2004-0029582.

### BACKGROUND OF THE INVENTION

1. Field of the Invention

The present invention relates to a novel design for a plasma display panel (PDP).

2. Description of the Related Art

Plasma display panels (PDPs) have received considerable attention as next-generation large flat panel displays because they are easier to manufacture than other flat panel displays and provide large size screen, high picture quality, super slim and lightweight design, and wide viewing angle. PDPs are divided into a DC type, an AC type, and a hybrid type according to a discharge voltage supplied. PDPs are also classified into an opposite discharge type and a surface discharge type according to a discharge structure. Three electrode surface discharge PDPs have been widely used in commercial applications.

PDPs are designed so that excited phosphor layers between a front and a rear substrate generate visible light. This visible light must pass through the front substrate to be viewed by a viewer. However, the front substrate also has on it a dielectric layer, a protective layer and an electrode structure. The electrode structure can be complex and consist of a transparent conductor and an opaque conductor. The presence of all of these elements on the front substrate cause about 40% of the generated visible light to be absorbed by the elements before it is ever viewed. This absorption cuts down on the luminous efficiency.

PDPs are also designed to produce a sustain discharge in the same space that phosphor layers are present. This too is problematical as ions in the plasma in such a design serve to sputter the phosphor layers causing the creation of a permanent burnt-in image or image sticking to occur. Therefore, what is needed is a design for a PDP that overcomes the problems of low luminous efficiency and image sticking while providing for improved image quality.

### SUMMARY OF THE INVENTION

It is therefore an object of the present invention to provide an improved design for a PDP.

It is also an object of the present invention to provide a design for a PDP that has superior luminous efficiency.

It is yet an object of the present invention to provide a design for a PDP that prevents the occurrence of image sticking.

It is further an object of the present invention to provide a design for a PDP that reduces the reflection of external light and improves image contrast while improving luminous efficiency and avoiding image sticking.

It is still an object of the present invention to provide a design for a (PDP) with improved driving efficiency.

These and other objects maybe achieved by a design for a PDP that includes a transparent upper substrate, a lower substrate oriented to be parallel to the upper substrate, a plurality of first barrier ribs that are made of a transparent dielectric material and arranged between the upper and lower substrates and define discharge cells in combination with the upper and lower substrates, top discharge electrodes formed within the first barrier ribs and surrounding the discharge cells, each discharge electrode having a dark-colored top surface, bottom discharge electrodes also formed within the first barrier ribs and also surrounding the discharge cells and spaced apart from the top discharge electrodes, a phosphor layer formed within the discharge cells and a discharge gas filling the discharge cell.

The dark color can be black. The dark colored top surface includes at least one black coloring agent which includes one or more of Ru, Co, Fe, and Ti. This dark colored layer can be formed on the top surface of the top discharge electrode. Alternatively, the entire top discharge electrode can be dark-colored. The top discharge electrode can include an upper dark-colored layer and a lower light-colored layer. The thickness of the dark-colored layer can be in the range of 0.5 to 2 μm. The light-colored layer can be made of at least one of Al, Cu, and Ag. The light-colored layer is preferably twice as thick as the dark-colored layer.

The top and bottom discharge electrodes can extend in differing directions that intersect each other at the discharge cells. The top and bottom discharge electrodes can alternatively be designed to extend in the same direction and thus be parallel to one another. The PDP can further include address electrodes extending to intersect the top and bottom discharge electrodes in the discharge cells. The address electrodes can be arranged between the lower substrate and the phosphor layer, and a dielectric layer can be formed between the phosphor layer and the address electrodes. The PDP can further include second barrier ribs also defining the discharge cells in combination with the first barrier ribs. The phosphor layer can be formed to the same height as the second barrier ribs. The top and bottom discharge electrodes can respectively have a ladder-like shape. At least sides of the first barrier ribs can be covered by a protective layer.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in a which like reference symbols indicate the same or similar components, wherein:

FIG. 1 is an exploded perspective view of a plasma display panel (PDP);

FIG. 2 is an exploded perspective view of a PDP according to a first embodiment of the present invention;

FIG. 3 is a cross-sectional view of the PDP of FIG. 2 taken along line III-III;

FIG. 4 is a perspective view illustrating an electrode structure for the PDP of FIG. 2;

FIG. 5 is an exploded perspective view of a PDP according to a second embodiment of the present invention;

FIG. 6 is a cross-sectional view of the PDP of FIG. 5 taken along line VI-VI; and

FIG. 7 is an exploded perspective view of a PDP according to a third embodiment of the present invention.

### DETAILED DESCRIPTION OF THE INVENTION

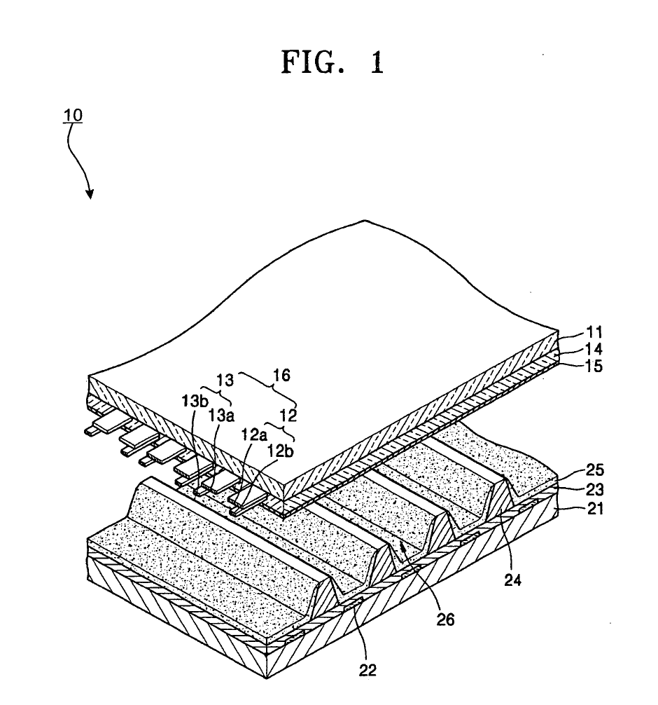

Turning now to the figures, FIG. 1 illustrates a three electrode surface discharge PDP 10. Referring to FIG. 1, the PDP 10 includes an upper substrate 11 and a lower substrate 21 positioned to face each other. A pair of discharge sustaining electrodes 16 are located on a bottom surface of the upper substrate 11 and covered by an upper dielectric layer 14, the upper dielectric layer is in turn covered by a protective layer 15. In the PDP 10 of FIG. 1, one of the pair of discharge sustaining electrodes 16 is a scanning electrode 12 that is made up of a transparent electrode 12a and a bus electrode 12b. The other of the pair of discharge sustaining electrodes 16 is a common electrode 13 that is made up of a transparent electrode 13a and a bus electrode 13b.

A plurality of address electrodes 22 are formed on a top surface of the lower substrate 21 and covered by a lower dielectric layer 23. These address electrodes 22 extend in parallel to each other and intersect each pair of discharge sustaining electrodes 16. A plurality of barrier ribs 24 are formed on the lower dielectric layer 23 in order to define a plurality of discharge cells 26 filled with a discharge gas (not illustrated). Phosphor layers 25 are formed on the lower dielectric layer 23 and on the barrier ribs 24.

In the PDP 10 of FIG.1, a discharge induced by the pair of discharge sustaining electrodes 16 produces a plasma that gives off vacuum ultraviolet radiation. The ultraviolet radiation excites the phosphor layers 25 that then emits visible light. The visible light is radiated through upper substrate 11 to form an image.

However, the three electrode surface discharge PDP 10 of FIG. 1 has a low luminous efficiency because about 40% of the visible light generated in the phosphor layers is absorbed as it passes through the pair of discharge sustaining electrodes 16, the upper dielectric layer 14 and the protective layer 15 formed on the bottom surface of the upper substrate 11. Another problem with the PDP 10 of FIG. 1 is that when the same picture is displayed for a long period of time, charged particles from the plasma in a discharge cells 26 gas collide with the phosphor layers 25, which causes a permanent after-image to remain on the PDP.

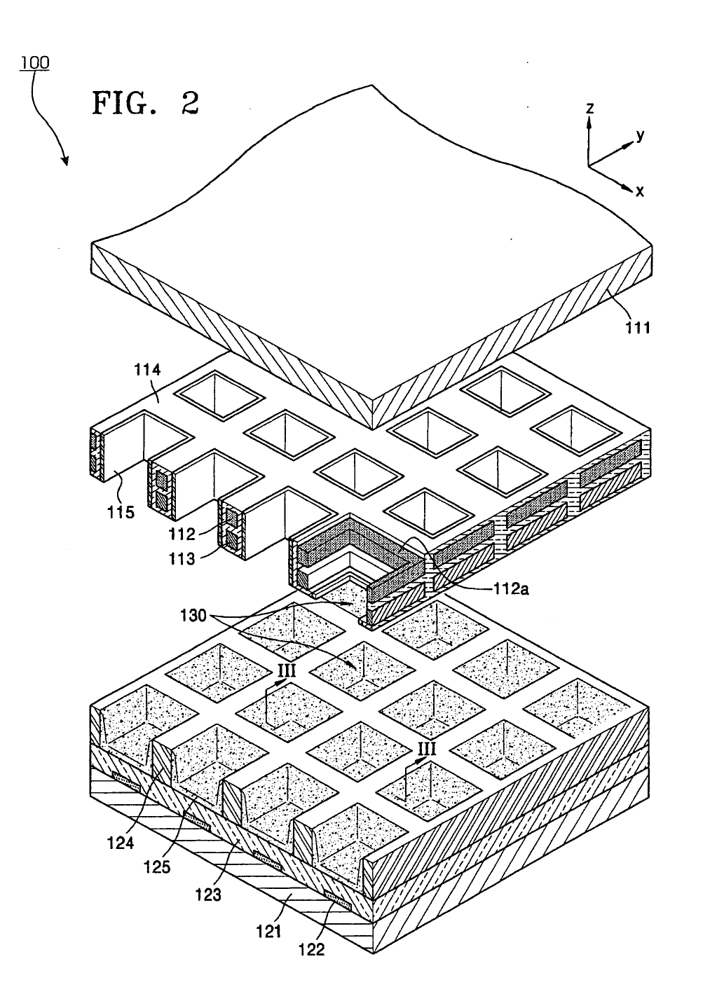

Turning now to FIGS. 2 through 4, FIGS. 2 through 4 illustrate a PDP 100 according to a first embodiment of the present invention. Referring to FIG. 2, the PDP 100 includes an upper substrate 111 and a lower substrate 121 oriented and positioned to face each other. The upper and lower substrates 111 and 121 are typically made of a material that mainly contains glass. In particular, the upper substrate 111, through which an image is displayed, can be made of a transparent material having excellent light transmittance.

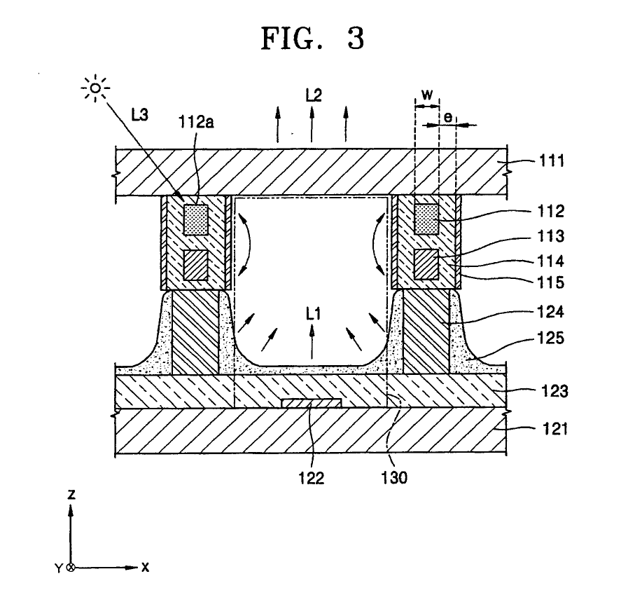

The upper and lower substrates 111 and 121 vertically define discharge cells 130. As indicated by the dotted line in FIG. 3, each discharge cell 130 includes an area vertically ranging from a bottom surface of the upper substrate 111 and a top surface of the lower substrate 121. More specifically, each discharge cell 130 is a discharge space surrounded by panel elements, a phosphor layer 125, a dielectric layer 123, and an address electrode 122. Each discharge cell 130 corresponds to a pixel, each pixel in turn is made up of red, green, and blue sub-pixels.

Referring to FIG. 2, a plurality of first barrier ribs 114 are formed on the bottom surface of the upper substrate 111 and define the sides of each discharge cell 130 in order to prevent discharge or interference between neighboring discharge cells 130. While the plurality of first barrier ribs 114 illustrated in FIG. 2 are shown to extend along x and y directions in the form of a matrix, the barrier ribs can instead form open-type barrier ribs such as striped ribs or closed-type barrier ribs such as waffle or delta ribs and still be within the scope of the present invention. While it is illustrated in FIG. 2 that the first barrier ribs 114 have a rectangular shape when viewed from above, they can instead have other polygonal shapes such as triangular or pentagonal or be curved and take on a circular or an elliptical shape.

The first barrier ribs 114 are made of a dielectric material such as PbO, B₂O₃, or SiO₂ to prevent direct conduction between top and bottom discharge electrodes 112 and 113 during discharge while allowing for a build-up of wall charges near the discharge electrodes. When the dielectric material is transparent, the dark-colored top discharge electrode 112 serves to absorb light emitted from an external light source, thus improving the contrast of an image displayed on the PDP 100. Sidewalls of the first barrier ribs 114 can be covered by a protective layer 115. The protective layer 115 is typically made from MgO and serves to protect the first barrier ribs 114 from colliding with charged particles in the plasma discharge. The protective layer 115 also serves to release a large amount of secondary electrons. The top and bottom discharge electrodes 112 and 113 are buried inside the first barrier rib 114 and are vertically spaced apart from each other by a predetermined distance. Sustaining discharge occurs between the top and bottom discharge electrodes 112 and 113.

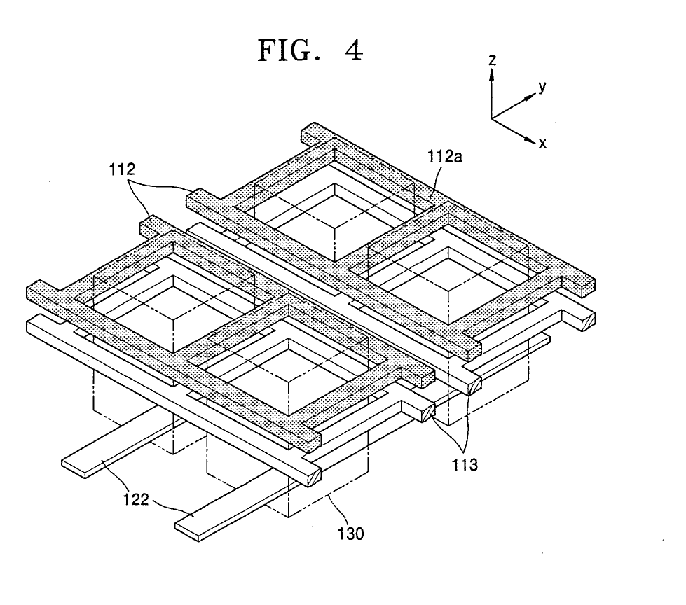

Turning now to FIG. 4, FIG. 4 is a perspective view illustrating an electrode structure for the PDP of FIG. 2. Referring to FIG. 4, the top and bottom discharge electrodes 112 and 113 are illustrated as being arranged in parallel to each other. Having a ladder-like shape, the top and bottom discharge electrodes 112 and 113 extend in the x direction and surround individual discharge cells 130. In this first embodiment, the entire top discharge electrode 112, including the top surface 112a has a dark color. In later embodiments to be described later, only a top portion of the top discharge electrode is dark in color. Here, the dark color refers to a color having a value (V) of 6 to 10 in a Munsell color system and absorbs light well.

As illustrated in FIG.3, the dark-colored top discharge electrode 112 absorbs external light L3 incident on the PDP 100 in order to reduce reflective brightness due to the external light L3, thus improving daylight contrast of the PDP 100. A width W of the top discharge electrode 112 can be increased to improve absorption of external light. Furthermore, a barrier rib width e between the side of the top discharge electrode 112 and the sidewall of the first barrier rib 114 should be designed to be sufficiently thick enough to prevent damage to the first barrier rib 114 due to a discharge voltage.

The top discharge electrode 112 can be formed by printing a paste containing a blend of highly conductive metal such as Ag and at least one of Ru, Co, Fe, and Ti as a coloring agent. The highly conductive Ag is mixed into the paste to limit or reduce the resistivity of the top discharge electrode 112 containing the coloring agent. By including enough Ag in the dark-colored top discharge electrode 112, a reduction in driving efficiency due to resistance of the top discharge electrode 112 can be avoided.

The bottom discharge electrode 113 can be made of highly conductive metal such as Al, Cu, or Ag and can be formed to have a light color. The light color refers to a color having a value (V) of 1 to 5 in the Munsell color system. By using the highly conductive metal for the bottom discharge electrode 113, it is possible to improve driving efficiency and response speed of the PDP 100 by reducing a voltage drop that occurs along the bottom discharge electrode 113 line and allowing for a uniform voltage to be applied to discharge cells 130 furthest away from a voltage source.

One of the top and bottom discharge electrodes 112 and 113 acts as a scan electrode while the other acts as a common electrode. Since an address voltage is lowered when a scan electrode is located adjacent to an address electrode 122, the bottom discharge electrode 113 adjacent to the address electrode 122 can be used as the scan electrode in the present embodiment. Referring to FIG. 4, when the bottom discharge electrode 113 acts as the scan electrode, the bottom discharge electrode 113 and the address electrode 122 extend to intersect each other. This means the direction (x direction) that the bottom discharge electrode 113 passes intersects the direction (y direction) that the address electrode 122 passes.

Referring to FIG. 2, a plurality of address electrodes 122 are arranged on the lower substrate 121 in a striped pattern. Each address electrode 122 extends along one column of discharge cells 130. As illustrated in FIG. 4, the address electrodes 122 extend in the direction (y direction) perpendicular to the direction (x direction) that the top and bottom discharge electrodes 112 and 113 extend. The address electrode 122 is used to induce an address discharge for the subsequent sustain discharge. The address discharge serves to select the proper discharge cell and to allow the sustain discharge to be initiated at a smaller voltage. When the address discharge between the scan electrode and the address electrode 122 terminates, positive ions and electrons are accumulated on the scan electrode and the common electrode, respectively, thus facilitating the sustain discharge that subsequently occurs between the scan electrode and the common electrode. By decreasing a gap between the scan electrode and the address electrode 122, the efficiency of the address discharge can be increased. Thus, in the first embodiment, the bottom discharge electrode 113, and the top discharge electrode 112 are used as the scan electrode and the common electrode respectively.

Although FIGS. 2 through 4 illustrate the presence of a separate address electrode 122 on the lower substrate 121, it is possible to design the PDP where the separate address electrode 122 can be absent. When address electrode 122 is not present, it is still possible to achieve a discharge between the top and bottom discharge electrodes 112 and 113. When the address electrode 122 is absent, the top and bottom discharge electrodes 112 and 113 must be designed so that they intersect each other in each discharge cell 130 as opposed to being in parallel to each other. Referring to FIG. 4, for example, when the top discharge electrode 112 extends in the x direction, the bottom discharge electrode 113 extends in the y direction perpendicular to the x direction when address electrode 122 is absent.

Referring to FIG. 2, the address electrodes 122 are covered by a dielectric layer 123. The dielectric layer 123 can be made of a dielectric material such as PbO, B₂O₃, or SiO₂. Dielectric layer 123 serves to induce wall charges and to prevent damage to the address electrodes 122 due to collision with charged particles in a discharge gas with the address electrodes 122.

As illustrated in FIG. 2, a plurality of second barrier ribs 124 are arranged on the dielectric layer 123 and also defines the sides of the discharge cells 130 in combination with the first barrier ribs 114. While the second barrier ribs 124 are illustrated as having a matrix design extending along the x and y directions, they can instead be designed to have other structures. For example, the second barrier ribs 124 can be an open-type barrier rib structure such as a striped structure or a closed-type barrier rib structure such as a waffle or delta structure. While being rectangular when viewed from above, the second barrier ribs 124 can also be in the form of other polygons, such as a triangle or a pentagon. Second barrier ribs 124 can instead have a curved shape and be circular or elliptical.

The phosphor layer 125 is formed to the same height as the second barrier ribs 124. More specifically, the phosphor layer is formed on the dielectric layer 123 and on sidewalls of the second barrier ribs 124. The phosphor layer 125 is not formed on the sidewalls of the first barrier ribs 123 near the top and bottom discharge electrodes. Since the phosphor layer 125 is formed on a portion of the discharge cells 130 that is away from the top and bottom discharge electrodes 112 and 113, plasma generated during the sustain discharge does not interact with and sputter the phosphor layer 125, thus overcoming the problem of image sticking.

Each discharge cell 130 is subdivided into red, green, and blue sub-pixels depending on the type of phosphor used. The phosphor layer 125 contains phosphors that convert vacuum ultraviolet rays produced by plasma in a sustain discharge into visible light. For example, the phosphor layer 125 formed in the red sub-pixel contains a phosphor such as Y(V,P)O₄:Eu. The phosphor layer 125 formed in the green sub-pixel contains a phosphor such as Zn₂SiO₄:Mn or YBO₃:Tb. The phosphor layer 125 formed in the blue sub-pixel contains a phosphor such as BAM:Eu.

A discharge gas such as Ne, Xe, or a Ne—Xe gas mixture is injected into the discharge cell 130. A PDP 100 according to the present invention including the present embodiment can increase a discharge surface or a discharge area and the amount of plasma generated, thus allowing for low-voltage driving. Thus, the PDP 100 using a high concentration of Xe gas as a discharge gas enables low-voltage driving, thus significantly improving luminous efficiency. This is an improvement over the PDP 10 of FIG. 1 which requires a large driving voltage when a high concentration Xe gas is used as the discharge gas.

The transparent upper substrate 111 is made of a material having good light transmittance, such as glass. Since the upper substrate 111 does not have a pair of discharge electrodes formed on the upper substrate 111 and does not have a dielectric layer covering the pair of discharge electrodes on the upper substrate 111, a much higher percentage of visible light is transmitted through the upper substrate 111 of PDP 100 of FIGS. 2 through 4 than through upper substrate 11 of PDP 10 of FIG. 1. That is, referring to FIG. 3, most visible light L1 generated in the phosphor layer 125 and traveling towards the upper substrate 111 is transmitted through the upper substrate 111 and is emitted as display light L2. Because of the higher transmittance of the upper substrate 111, the top and bottom discharge electrodes 112 and 113 can be driven at a lower voltage and still achieve the same image brightness as PDP 10 in FIG. 1. When the same voltage is applied to the electrodes 112 and 113 as is done, the luminous brightness of the PDP is improved.

Since the top and bottom discharge electrodes 112 and 113 are located on the sides of a discharge space rather than on the upper substrate 111 , the need to use a high-resistance transparent electrode in the discharge electrodes is eliminated. By using only low-resistance metal electrodes as the top and bottom discharge electrodes 112 and 113, the resulting PDP 100 achieves high-speed discharge response, low driving voltages and no wave distortion.

In the PDP 100 having the above-mentioned construction according to the first embodiment of the present invention, applying an address voltage between the address electrode 122 and the bottom discharge electrode 113 induces an address discharge during which the discharge cell 130 is selected for the subsequent sustain discharge. When an AC sustain discharge voltage is applied between the top and bottom discharge electrodes 112 and 113 of the selected discharge cell 130, a sustain discharge occurs therebetween. When the energy level of a discharge gas excited by the sustain discharge decreases, ultraviolet rays are produced. The ultraviolet rays excite the phosphor layer 125 within the discharge cell 130 to produce visible light when the energy level of the phosphor layer 125 decreases. The visible light is transmitted through upper substrate 111 to form an image.

While the PDP 10 of FIG. 1 has a narrow discharge area since sustaining discharge occurs horizontally between the scan electrode 12 and the common electrode 13, the PDP 100 according to the present invention provides a wide discharge area since the sustain discharge vertically occurs along sides of the discharge cell 130 defined by the first barrier rib 114.

The sustain discharge in the illustrated embodiment first occurs along the sides of the discharge cell 130, forming a closed curve, and then extends toward the center of the discharge cell 130. Thus, the volume of a sustain discharge area increases, and space charges within the discharge cell 130 not used contribute to luminance. This leads to improved luminous efficiency in the PDP 100.

In the PDP 100 according to the present embodiment, since sustain discharge occurs only within a portion defined by the first barrier rib 114 as illustrated in FIG. 3, this prevents ion sputtering of the phosphor layer 125 caused by charged particles, thus overcoming the problem of a permanent after-image occurring when the same picture is displayed for a long period of time.

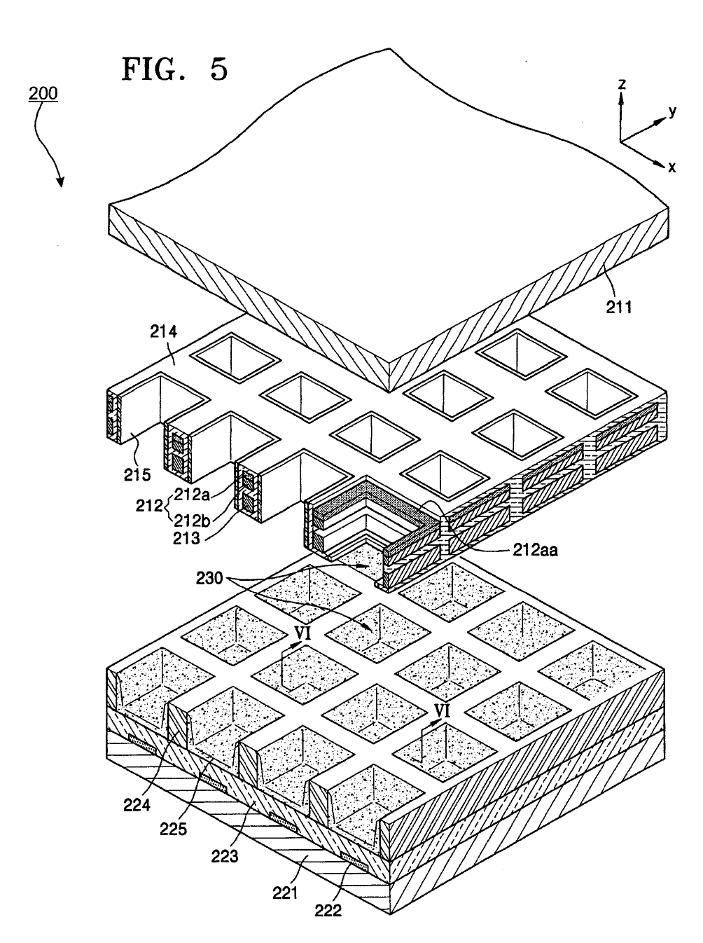

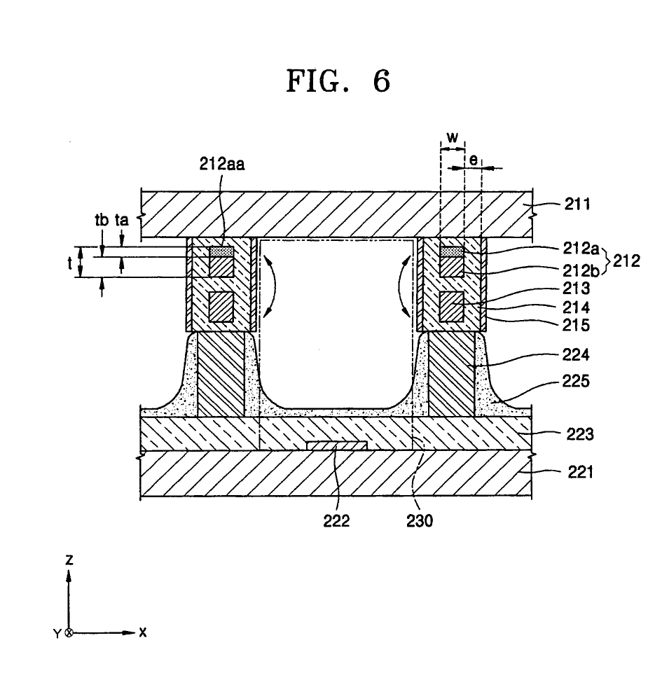

Turning now to FIGS. 5 and 6, FIGS. 5 and 6 illustrate a PDP 200 according to a second embodiment of the present invention. Specifically, FIG. 5 is an exploded perspective view of PDP 200 according to a second embodiment of the present invention and FIG. 6 is a cross-sectional view of PDP 200 taken along line VI-VI of FIG. 5. Differences between the first and second embodiments will now be described. The PDP 200 according to the second embodiment of the present invention includes an upper substrate 211 and a lower substrate 221 facing each other. A plurality of first barrier ribs 214 and a plurality of second barrier ribs 224 are arranged between the upper and lower substrates 211 and 221 and define a plurality of discharge cells 230. Top and bottom discharge electrodes 212 and 213 are buried within the first barrier ribs 214 and are vertically spaced apart from each other by a predetermined distance. While a top surface 212aa of the top discharge electrode 212 has a dark color according to the present invention, the top discharge electrode 212 in the present embodiment consists of an upper dark-colored layer 212a and a lower light-colored layer 212b. This is different from the PDP 100 according to the first embodiment where the top discharge electrode 112 was entirely made out of a dark colored layer and did not include a light colored highly conductive layer.

Referring to FIG. 6, a thickness ta of the dark-colored layer 212a in the range of 0.5 to 2 μm. When the thickness ta of the dark-colored layer 212a is less than 0.5 μm, the dark-colored layer 212a tends to be broken and isolated during its formation. When viewed from above, the dark-colored layer 212a with a thickness less than 0.5 μm does not have sufficiently low brightness to absorb external light. On the other hand, when the thickness ta of the dark-colored layer 212a is greater than 2 μm, the excess thickness above 2 μm does not serve to further improve upon the brightness of the dark-colored layer 212a or absorption rate of external light. Furthermore, thicknesses of the dark-colored layer in excess of 2 μm causes an increase in resistance along the top discharge electrode 212, resulting in a decrease in driving efficiency and a decrease in response speed of the PDP. Also, such excess thickness of the dark-colored layer results in non-uniform voltage distributions, especially in discharge cells furthest away from a voltage source.

The presence of the dark-colored layer 212a serves to improve image contrast by absorbing external light incident on the PDP 200. The dark-colored layer 212a can be formed by printing a paste that contains a blend of highly conductive metal such as Ag and at least one coloring agent, such as Ru, Co, Fe, and Ti. In order to improve the electrical conduction characteristics of the dark-colored layer 212a, the highly conductive Ag is used to boost the electrical conductivity of the dark-colored layer 212a containing the coloring agent.

The light-colored layer 212b is made up of highly conductive metal such as Al, Cu, or Ag and is preferably formed to be at least twice as thick as the dark-colored layer 212a. The overall conduction characteristics of the top discharge electrode 212 is determined by the compositions and thicknesses of the dark and light-colored layers 212a and 212b and can be improved by forming the light-colored layer 212b having superior conduction characteristics to be thicker than the dark-colored layer 212a. The overall thickness t of the entire top discharge electrode 212 is equal to the sum of thickness ta of the dark-colored layer 212a and thickness tb of the light-colored layer 212b. To further improve absorption of external light, a width W of the top discharge electrode 212, preferably, a width of the dark-colored layer 212a, can be increased. A barrier rib width e between the side of the top discharge electrode 212 and the sidewall of the first barrier rib 214 should be maintained at a sufficient thickness.

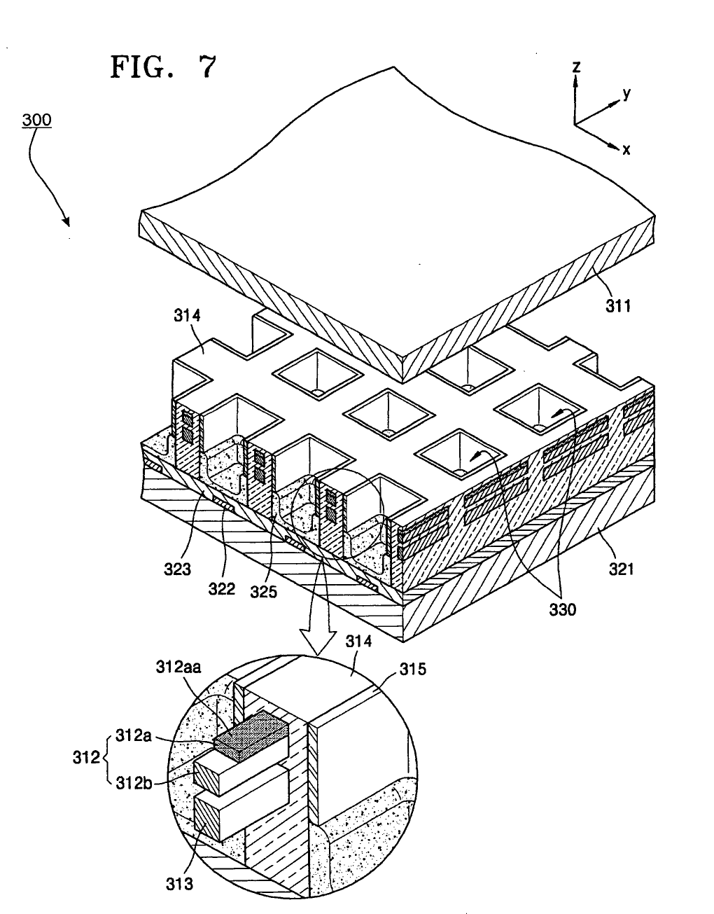

Since other elements of PDP 200 such as the upper substrate 211, first barrier rib 214, bottom discharge electrode 213, protective layer 215, second barrier rib 224, dielectric layer 223, address electrode 222, and lower substrate 221 have substantially the same structures and functions as their counterparts in the PDP 100 of the first embodiment, detailed descriptions thereof will not be given. Turning now to FIG. 7, FIG. 7 illustrates a PDP 300 according to a third embodiment of the present invention. The PDP 300 according to the third embodiment of the present invention includes an upper substrate 311 and a lower substrate 321 positioned and oriented to face each other. A plurality of first barrier ribs 314 are arranged between the upper and lower substrates 311 and 321 and define sides of a plurality of discharge cells 330. Top and bottom surfaces of the discharge cell 330 are defined by the upper and lower substrates 311 and 312. While a top surface 312aa of a top discharge electrode 312 has a dark color according to the present invention, the top discharge electrode 312 in the present third embodiment consists of an upper dark-colored layer 312a and a lower light-colored layer 312b, as in PDP 200 of the second embodiment. The dark and light-colored layers 312a and 313b have substantially the same structures and functions as their counterparts in the second embodiment.

Differences between PDP 200 of the second embodiment and PDP 300 of the third embodiments will now be described with reference to FIG. 7. Unlike in the second embodiment, the barrier ribs 314 defining the sides of the discharge cells 330 of PDP 300 in the third embodiment are integrally formed instead of being separated into two parts. In the second embodiment illustrated in FIG. 6, the PDP 200 is formed by attaching an upper structure including the upper substrate 211 with the first barrier ribs 214 thereon to a lower structure including the lower substrate 221 with the second barrier ribs 224 thereon. Such a process can cause misalignment between the upper and lower structures. The third embodiment eliminates the risk of misalignment between a first and a second barrier rib by forming the first and the second barrier ribs integrally, so that they do not have to be aligned with each other when making the PDP 300.

Since other elements such as the upper substrate 311, bottom discharge electrode 313, protective layer 315, dielectric layer 323, address electrode 322, and lower substrate 321 have substantially the same structures and functions as their counterparts in the second embodiment, detailed descriptions thereof will not be given.

Since an upper substrate in the PDP of the present invention does not have a pair of discharge electrodes and a dielectric layer formed on the upper substrate, the percent of visible light that transmits through the upper substrate according to the PDPs of the present invention is significantly improved over the PDP 10 of FIG. 1. Thus, when the same voltage is applied to discharge electrodes in the PDPs according to the present invention, the brightness of the displayed image is increased. The PDP of the present invention also enables a top discharge electrode having a dark-colored top surface to absorb external light incident on the PDP, thus providing improving daylight contrast. In particular, a top discharge electrode with dark- and light-colored layers helps to improve daylight contrast of the PDP. Furthermore, the light-colored layer is formed in such a way as to compensate for the electrical characteristics of the dark-colored layer, thus minimizing degradation of driving efficiency and response speed due to the higher electrical resistance of the coloring agent.

While the present invention has been particularly illustrated and described with reference to exemplary embodiments thereof, it will be understood by those of ordinary skill in the art that various changes in form and details can be made therein without departing from the spirit and scope of the present invention as defined by the following claims.

1. A plasma display panel (PDP), comprising:
a transparent upper substrate;
a lower substrate arranged parallel to the upper substrate;
a plurality of first barrier ribs arranged between the upper and lower substrates, the plurality of first barrier ribs define discharge cells in combination with the upper and lower substrates;
top discharge electrodes arranged within the first barrier ribs and surrounding the discharge cells, each electrode having a dark-colored top surface;
bottom discharge electrodes arranged within the first barrier ribs and surrounding the discharge cells and spaced apart from the top discharge electrodes;
a phosphor layer arranged within the discharge cells; and
a discharge gas arranged within the discharge cells.

2. The PDP of claim 1, the dark-colored top surface being black.

3. The PDP of claim 1, at least one coloring agent comprising a material selected from the group consisting of Ru, Co, Fe and Ti, the at least one coloring agent being arranged on the top surface of the top discharge electrode.

4. The PDP of claim 1, entire top discharge electrode being dark in color.

5. The PDP of claim 1, the top discharge electrode comprises:
an upper dark-colored layer; and
a lower light-colored layer.

6. The PDP of claim 5, a thickness of the dark-colored layer being in the range of 0.5 to 2 μm.

7. The PDP of claim 5, the light-colored layer comprising at least one metal selected from the group consisting of Al, Cu and Ag.

8. The PDP of claim 5, the light-colored layer being at least twice as thick as the dark-colored layer.

9. The PDP of claim 1, the top and bottom discharge electrodes extending to intersect each other at the discharge cells.

10. The PDP of claim 1, the top and bottom discharge electrodes both extend in a first direction, the PDP further comprising address electrodes extending in a second and different direction that intersects both the top and bottom discharge electrodes at the discharge cells.

11. The PDP of claim 10, the address electrodes being arranged between the lower substrate and the phosphor layer, the PDP further comprising a dielectric layer arranged between the phosphor layer and the address electrodes.

12. The PDP of claim 1, further comprising second barrier ribs defining the discharge cells in combination with the first barrier ribs, the phosphor layer being arranged to have a same height as the second barrier ribs.

13. The PDP of claim 1, each of the top and bottom discharge electrodes being of a ladder-like shape, the PDP further comprising a protective layer arranged on at least sides of the first barrier ribs.

14. The PDP of claim 1, the first barrier ribs being transparent.

15. The PDP of claim 1 1, the first barrier ribs extending from the transparent upper substrate to the dielectric layer on the lower substrate, the first barrier ribs being transparent.

16. The PDP of claim 1, the discharge gas comprising a high concentration of Xe gas.

17. A plasma display panel (PDP), comprising:
a transparent upper substrate;
a lower substrate arranged parallel to the upper substrate;
a plurality of transparent, dielectric barrier ribs arranged between the upper and lower substrates, the plurality of barrier ribs define discharge cells in combination with the upper and lower substrates;
top discharge electrodes arranged within the barrier ribs and surrounding the discharge cells, a portion of the top discharge electrodes closest to the upper substrate being of a dark-colored top surface;
bottom discharge electrodes arranged within the barrier ribs and surrounding the discharge cells and spaced apart from the top discharge electrodes, the bottom discharge electrodes being further from the upper substrate than the top discharge electrodes;
a phosphor layer arranged within the discharge cells; and
a discharge gas arranged within the discharge cells.

18. The PDP of claim 17, said portion of the top discharge electrodes closest to the upper substrate and having a dark-colored top surface being 0.5 to 2.0 μm thick and having a value (V) of 1 to 5 in the Munsell color system.

19. The PDP of claim 17, the phosphor layer being arranged closer to the lower substrate than either of the top and the bottom discharge electrodes.

20. The PDP of claim 17, the transparent upper substrate being absent of electrodes.
